(19) United States
(12) Patent Application Publication
(10) Pub. No.: US 2002/0120602 A1
(43) Pub. Date: Aug. 29, 2002

(54) System, method and computer program product for simultaneous analysis of multiple genomes

(76) Inventors: Ross Overbeek, Lisle, IL (US); Eugene Selkov JR., Naperville, IL (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 09/794,411

(22) Filed: Feb. 28, 2001

(51) Int. Cl. G06F 7/00

(52) U.S. Cl. 707/1

(57) ABSTRACT

A system, method, and computer program product for assisting in the analysis of biological data. The system enables a user to compare multiple genomes simultaneously. More particularly, the system operates by allowing a user to select a template genome and at least one comparison genome. The genes of the template genome are then projected across the comparison genomes and the results are displayed. The display aids the user in evaluating the quality of genome annotations and is particularly useful for quickly identifying functional relationships.

### STATEMENT REGARDING FEDERALLY-SPONSORED RESEARCH AND DEVELOPMENT

Not applicable.

### BACKGROUND OF THE INVENTION

1. Field of the Invention

The present invention relates generally to bioinformatics. More particularly, the present invention provides a computer based system, method, and computer program product for simultaneous analysis of multiple genomes.

2. Related Art

Bioinformatics is the recognized term for describing the application of computer technology to the field of biotechnology. Scientific research has generated a massive amount of data and the use of computers in the biotechnology field has proven invaluable in aiding the process of analyzing this data. Indeed, the introduction of sophisticated computer tools into the scientific research area has enabled scientists to obtain results that would ordinarily take months or years to achieve in the lab. However, the technology has presented at least two challenges for scientists.

First, the complex nature of the biological data requires complex tools for analysis. Consequently, scientists face the sometimes daunting task of learning to manipulate sophisticated computer applications. Second, currently available tools do not necessarily generate results which are immediately useful to the scientists. Thus, it is often necessary for scientists to perform further analysis of computer generated research data before meaningful information is obtained.

Genome sequencing is one of the most active areas in the field of biotechnology. Consequently, the number of sequenced genomes is growing rapidly. Inevitably, scientists wish to perform detailed comparison of the genomes to identify what is in common and what differentiates them. Known methods for performing such comparisons are limited in both their efficiency and effectiveness.

For example, one approach analyzes genomes by lining them up beside one another. The differences and similarities are then mapped gene by gene. This technique makes it difficult to portray inconsistencies in a reasonable way. Thus, this method is only beneficial when the genomes being compared are closely related to one another.

A second approach examines the genes from a given genome and assigns them into functional groupings (or “protein families”). The genes associated with a particular functional group are then compared to the genes in a comparison genome to identify corresponding functional groupings. The disadvantage of this approach is that any information relating to position on the chromosome is lost. None of the genomes is thought of as “ordered by location on the chromosome”.

Accordingly, in order to derive full benefits from the available data, it is necessary to have tools that help to efficiently analyze the data and provide results that are meaningful and more immediately useful. More particularly, a need exists for a way of simultaneously analyzing multiple genomes that may be dissimilar.

### SUMMARY OF THE INVENTION

Briefly stated, the present invention is directed to a system, method, and computer program product for assisting in the analysis of biological data. In particular, the present invention helps a user compare multiple genomes simultaneously. The present invention also aids the user in evaluating the quality of genome annotations and is particularly useful for quickly identifying functional relationships.

In an embodiment, the present invention operates by allowing a user to select a template genome and at least one comparison genome. The invention then projects the genes of the template genome across the comparison genomes and displays the comparative results. In one embodiment, the user is further able to select a specific gene or function and then project this specific selection across the comparison genomes.

In an embodiment, the present invention provides a system for analyzing multiple genomes simultaneously. The system includes a genome information database for storing genome information. The system further includes a genome analysis module in communication with the genome information database. The genome analysis module uses the stored genome information to execute at least one genome search query for comparing a template genome with at least one comparison genome, having a different chromosomal order.

Further features and advantages of the present invention, as well as the structure and operation of various embodiments of the invention, are described in detail below with reference to the accompanying drawings. In the drawings, like reference numbers generally indicate identical, functionally similar and/or structurally similar elements. The drawing in which an element first appears is generally indicated by the leftmost digit(s) in the corresponding reference number.

### BRIEF DESCRIPTION OF THE FIGURES

The present invention will be described with reference to the accompanying drawings, wherein:

FIG. 1 is a block diagram of a genome analysis system according to an embodiment of the present invention;

FIG. 2 is a block diagram of a computer system embodiment of the present invention;

FIG. 3 is an illustration depicting a genome analysis system from the perspective of a user according to an embodiment of the present invention;

FIG. 4 is an illustration depicting a genome comparison screen according to an embodiment of the present invention;

FIG. 5 is a flow chart diagram of a genome analysis routine according to an embodiment of the present invention;

FIG. 6 is a flow chart diagram of a genome query generation routine according to an embodiment of the present invention;

FIG. 7 is a flow chart diagram of a genome query execution routine according to an embodiment of the present invention;

FIGS. 8, 9, 10, 11A-B, 12, 13, and 14 are example screen shots generated by a graphical user interface according to an embodiment of the present invention.

FIG. 11C indicates the orientation of FIGS. 11A-B according to an embodiment of the present invention;

FIG. 15 is an illustration depicting a server architecture environment according to an embodiment of the present invention; and

FIG. 16 is a flow chart diagram of a gene projection routine according to an embodiment of the present invention.

### DETAILED DESCRIPTION OF THE INVENTION

### Table of Contents

1. Overview of the Invention

2. Exemplary Structural Environment

2.1 Genome Analysis System

2.2 Computer System Embodiment

3. Exemplary Operation of the Invention

3.1 Genome Query Entry Method

3.2 Genome Query Execution Method

3.3 Method of Displaying Query Results

4. Example Usage of the Invention

4.1 Main Screen Shot

4.2 Detailed Search Screen Shot

4.3 Query Result Display Screen Shot

4.4 Gene Detailed Description Screen Shot

4.5 Contiguous Region Screen Shot

4.6 Metabolic Pathway Description Screen Shot

4.7 Metabolic Pathway View Screen Shot

5. Conclusion

1. Overview of the Invention

The present invention is directed to a system, method, and computer program product for enabling users to perform simultaneous comparisons and analysis of multiple genomes. The invention is particularly well suited and useful for identifying corresponding genes and functions among several genomes. The invention is also very useful for understanding the genetic pathways and chromosomal regions of genomes. The invention is further useful for quickly progressing through the genes along the chromosome.

The present invention projects the genes of a template genome across a number of identified comparison genomes in order to identify corresponding genes. Preferably, the present invention achieves this functionality by allowing a user to select a template genome from a first list of genomes and one or more comparison genomes from a second list of genomes. The invention then projects the genes from the template genome across the comparison genomes and produces an interactive display of the results.

In an embodiment, such projection is performed without regard to gene position (i.e., chromosomal ordering). That is, the invention does not attempt to maintain the chromosomal ordering of genes in any given comparison genome when the template genome is projected upon such comparison genome.

From the display, the user is able to visually identify functional relationships between the genes of the template genome as well as determine the strength of the projections across the comparison genomes.

2. Exemplary Structural Environment

2.1 Genome Analysis System

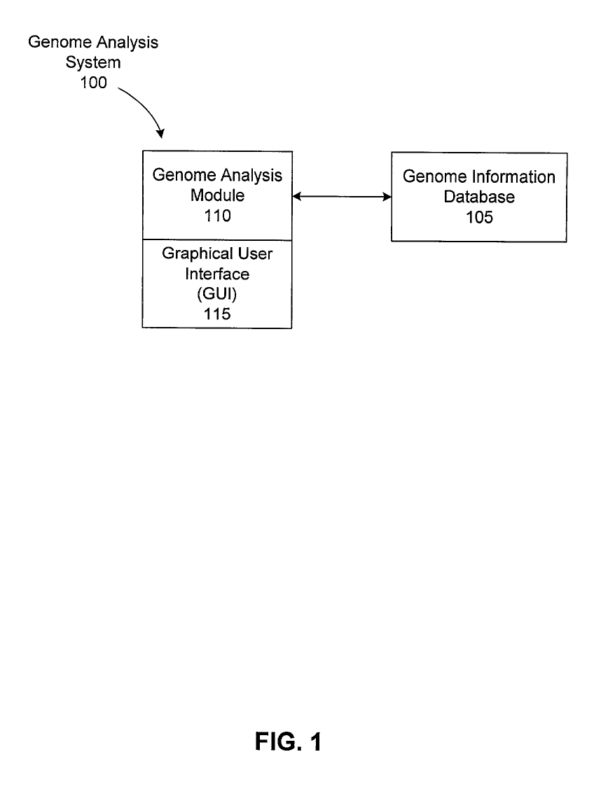

FIG. 1 is a block diagram of a genome analysis system 100 according to an embodiment of the present invention. The system 100 includes a genome information database 105. Genome information database 105 contains genome data such as gene identifiers, functions, and annotations, for example. The genome analysis system 100 further includes a genome analysis module 110. Genome analysis module 110 assists users in projecting genes across multiple genomes simultaneously. Genome analysis system 100 also includes a graphical user interface (GUI) 115. GUI 115 provides interaction between a user and genome analysis system 100. In particular, GUI 115 allows a user to access the functionality of genome analysis module 110.

The operational steps shown in flowchart 500 and in other flowcharts discussed below represent one example operational sequence of accessing the functions provided by the genome analysis module 110. Users may access and traverse the functions provided by the genome analysis module 110 in any number of ways via interaction with menus or icons provided by the GUI 115. Other ways of accessing genome analysis module 110 will be apparent to persons skilled in the relevant arts based at least on the teachings contained herein.

2.2 Computer System Embodiment

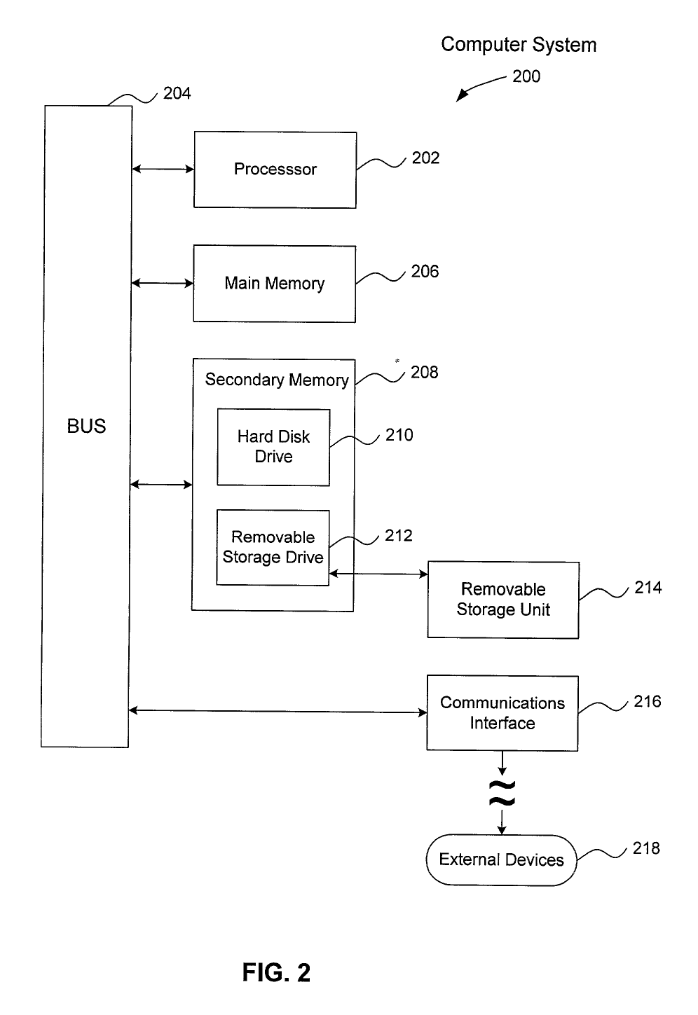

In an embodiment, the genome analysis system 100 is implemented using a computer system 200 such as that shown in FIG. 2.

The computer system 200 includes one or more processors 202. Processor 202 is connected to a communication bus 204. The computer system 200 also includes a main memory 206. Main memory 206 is preferably random access memory (RAM). Computer system 200 further includes secondary memory 208. Secondary memory 208 includes, for example, hard disk drive 210 and/or removable storage drive 212. Removable storage drive 212 could be, for example, a floppy disk drive, a magnetic tape drive, a compact disk drive, a program cartridge and cartridge interface, or a removable memory chip. Removable storage drive 212 reads from and writes to a removable storage unit 214. Removable storage unit 214, also called a program storage device or computer program product, represents a floppy disk, magnetic tape, compact disk, or other data storage device.

Computer programs or computer control logic are stored in main memory 206 and/or secondary memory 208. When executed, these computer programs enable computer system 200 to perform the functions of the present invention as discussed herein. In particular, the computer programs enable the processor 202 to perform the functions of the present invention. Accordingly, such computer programs represent controllers of the computer system 200. In an embodiment, genome analysis system 100 represents a computer program executing in the computer system 200.

In embodiments, the genome analysis system 100 is centralized in a single computer system 200. In other embodiments, the genome analysis system 100 is distributed among multiple computer systems 200. For example, the genome analysis module 110 could exist in a first set of computers 200. The genome information database 105 could exist in a second set of computers 200, and the GUI 115 could exist in a third set of computers 200, where each of these sets could include one or more computers 200, and the computers 200 communicate over a network (such as a local area network, a wide area network, point-to-point links, the Internet, etc., or combinations thereof). The degree of centralization or distribution is implementation and/or application dependent.

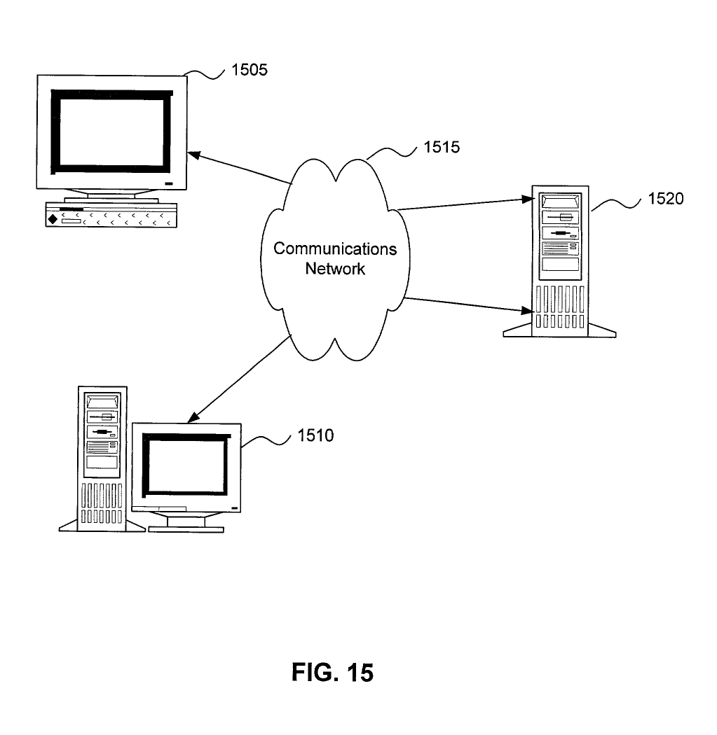

For example, consider FIG. 15 which illustrates example embodiments of the present invention. In one embodiment, genome analysis system 100 could reside in host computer 1520. A user would access genome analysis system 100 over communications network 1515 using an external device 218 (FIG. 2), depicted in the example as input/output terminal 1505.

In another embodiment, genome analysis module 110 and GUI 115 could reside in personal computer 1510. Using communications network 1515, personal computer 1510 would then access data from genome information database 115 residing on host computer 1520.

The invention is not limited to these example embodiments. Other implementations of the genome analysis system 100 will be apparent to persons skilled in the relevant arts based at least in part on the teachings contained herein.

Referring again to FIG. 2, computer system 200 further includes a communications interface 216. Communications interface 216 facilitates communications between computer system 200 and local or remote external devices 218. External devices 218 could be, for example, personal computers, displays, databases, and additional computer systems 200. In particular, communications interface 216 enables computer system 200 to send and receive software and data to/from external devices 218. Examples of communications interface 216 include a modem, a network interface, and a communications port.

In one embodiment, the invention is directed to a computer system 200 as shown in FIG. 2 and having the functionality described herein. In another embodiment, the invention is directed to a computer program product having stored therein computer software for controlling computer system 200 in accordance with the functionality described herein. In another embodiment, the invention is directed to a system and method for transmitting and/or receiving computer software having the functionality described herein to/from external devices 218.

3. Exemplary Operation of the Invention

3.1 Genome Query Entry Method

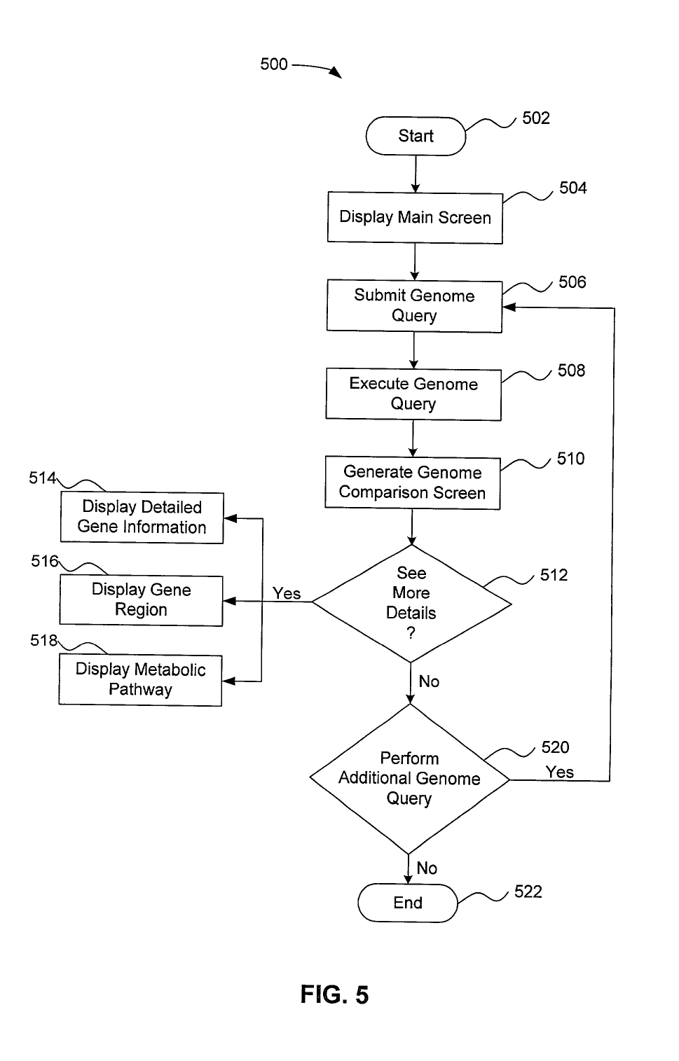

The operation of embodiments of the present invention will now be described with reference to flowchart 500 (FIG. 5).

Flowchart 500 illustrates one manner in which a user interacts with genome analysis system 100 via GUI 115 to compare and analyze genomes, although the invention is not limited to this example.

Flowchart 500 begins with step 502. In step 502, the user invokes genome analysis system 100 in any well known manner, such as selecting an icon associated with the genome analysis system 100.

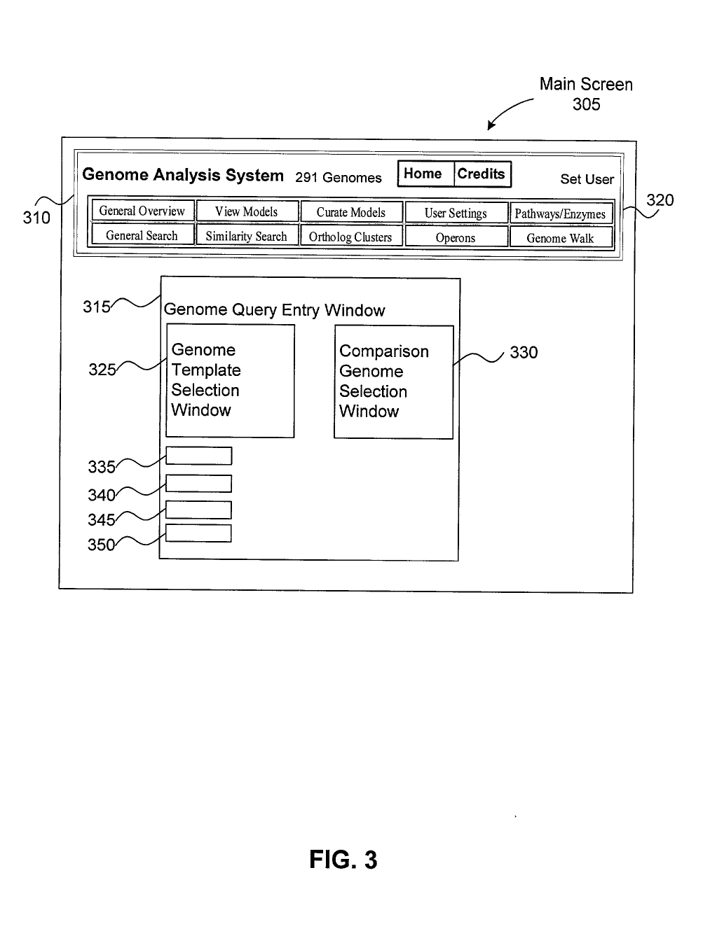

In step 504, genome analysis system 100 displays on a computer monitor, a main screen 305. See, for example, FIG. 3. Main screen 305 includes a system header window 310 and a genome query entry window 315. System header window 310 includes a number of command windows 320. Command windows 320 enable the present invention to serve as a portal for the user to access additional bioinformatics tools.

Genome query entry window 315 includes a genome template selection window 325, a comparison genome selection window 330, a gene specific search window 335, a detailed search entry window 340, an offset indicator window 345, and a query execution indicator 350. The manner of generating main screen 305 will be apparent to persons skilled in the relevant arts.

Genome template selection window 325 and comparison genome selection window 330 present the user with a list of genomes available from genome information database 105. Specific gene search window 335 allows a user to enter an identifier for a specific gene or open reading frame (ORF) that the user would like to focus his comparison on. Detailed search entry window 340 allows a user to enter specific search criteria upon which he would like to focus his comparison. Offset indicator window 345 allows the user to specify how many genes before or after a specified ORF should be displayed. Query execution indicator 350 allows a user to submit his query to genome analysis system 100 for execution.

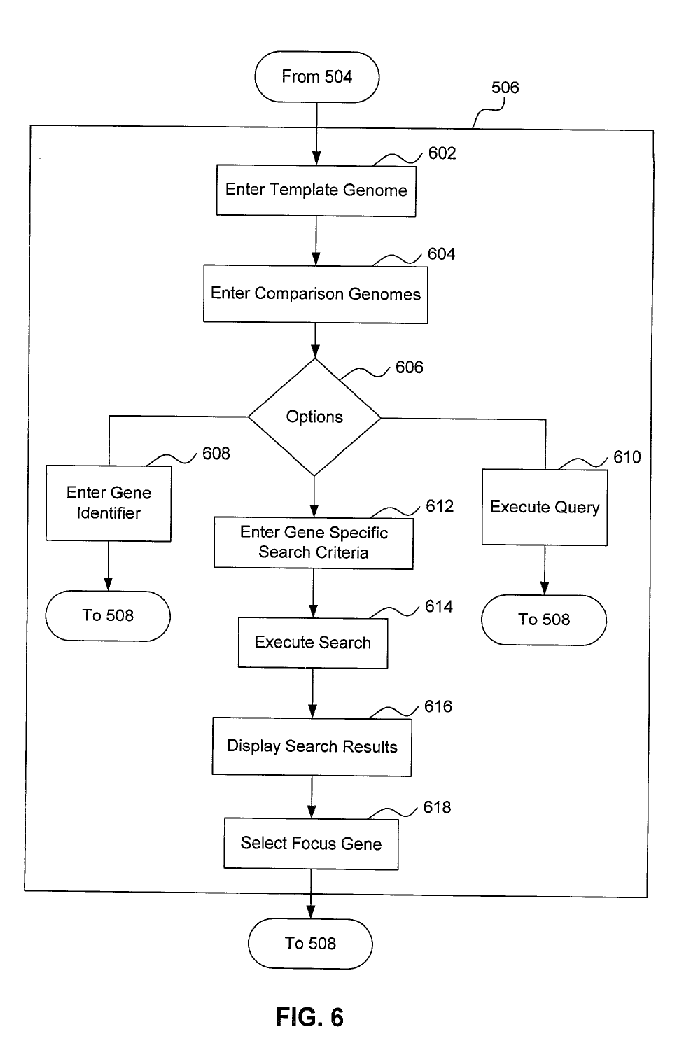

In step 506, the user builds the genome query. Further details of step 506 will be provided with reference to flowchart 600 (FIG. 6).

In step 602, the user selects a template genome from the list of genomes presented in genome template selection window 325. The user selects the template genome in any well known manner. For example, the selection could be made via a keyboard or perhaps through use of a pointing device like a mouse or trackball.

In step 604, the user selects at least one genome for comparison with the template genome from the comparison genome selection window 330. In an embodiment, the default is to have all available genomes selected for comparison. Genomes selected in step 604 are called comparison genomes.

In step 606, the user has three options: (1) entering an identifier for a specific ORF into specific gene search window 335; (2) entering search criteria into detailed search entry window 340; and (3) executing the query immediately.

If option (1) is chosen, then in step 608 the user enters an identifier previously assigned to represent a particular gene. For example, the user could enter REC04310 to indicate a desire to focus on the DNA POLYMERASE II gene of the template genome. Step 506 is completed upon the user's selection of the query execution indicator 350.

If option (2) is chosen, then in step 612 the user inputs search criteria in the detailed search entry window 340 to identify specific criteria he would like to focus his comparison on. For example, the user may want to identify a gene that functions as an “enzyme” or “polymerase”. In this case, he would enter the search criteria into detailed search entry window 340 and genome analysis system 100 would perform a search of genome information database 105 to identify genes satisfying the search criteria. In an embodiment, available search criteria includes gene functions, gene names, and gene identifiers, although the invention contemplates other search criteria.

Next in step 614, the user executes the detailed search by selecting query execution indicator 350. In response, genome analysis system 100 searches genome information database 105 for the search term entered in step 612.

In step 616, gene analysis system 100 displays on a computer screen or display, a list of genes satisfying the search criteria.

Next in step 618, the user selects a specific gene upon which to focus the comparative analysis. Control is then passed to step 508.

If option three (3) is desired, then in step 610 control is passed immediately back to step 506. Step 506 is completed upon the users selection of the query execution indicator 350.

3.2 Genome Query Execution Method

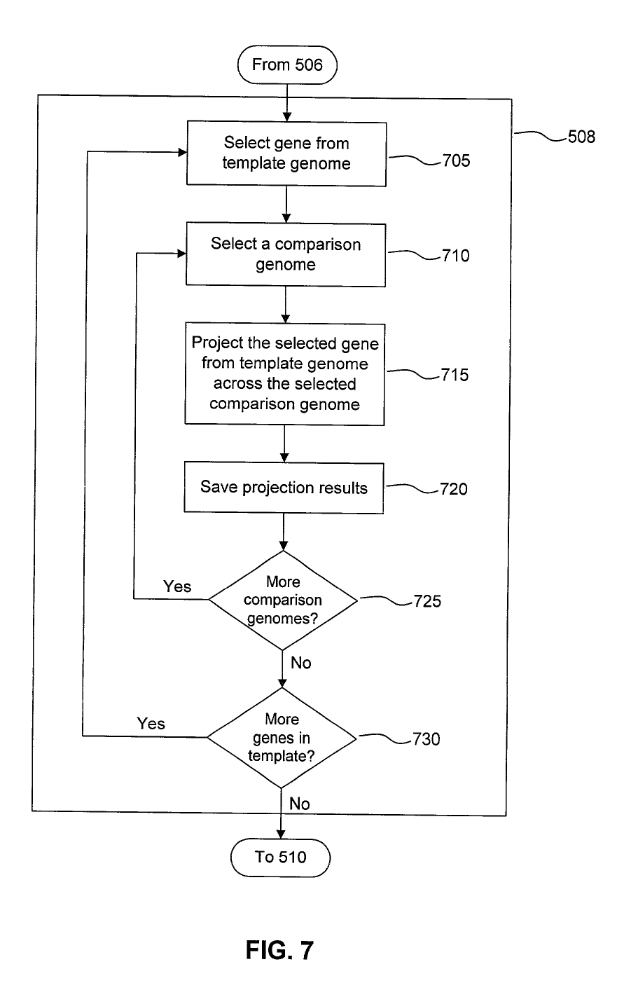

Referring again to FIG. 5, in step 508, genome analysis system 100 reads the query entered by the user in step 506 and executes it using genome information obtained from genome information database 105. Flowchart 700 (FIG. 7) illustrates one manner in which genome analysis system 100 executes the query.

In step 705, genome analysis system 100 obtains from genome information database 105, genomic data related to the first gene appearing in the template genome identified in step 506.

In step 710, genome analysis system 100 selects one of the comparison genomes identified in step 506, and obtains its genomic data from genome information database 105.

In step 715, genome analysis system 100 projects the first gene across the selected comparison genome using one or more genome comparison routines to identify a corresponding gene.

A variety of genome comparison routines exist. Any combination of these routines can be used in the present invention. For illustrative purposes, three example genome comparison routines shall now be described. However, it should be understood that the invention is not limited to these example routines.

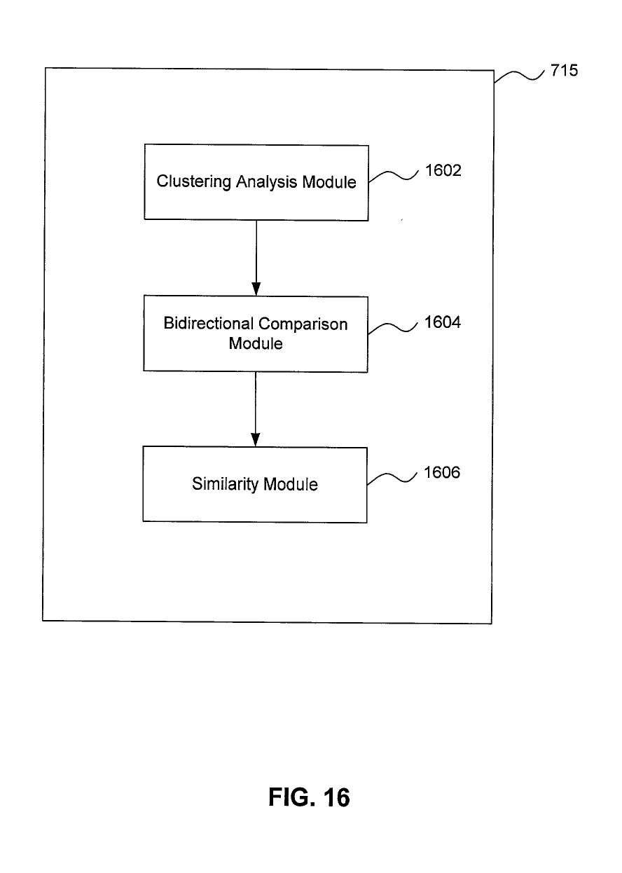

One genome comparison routine is based upon clustering analysis 1602 (FIG. 16). In clustering analysis, genes within different genomes are grouped when they fulfill a set of criteria, and all of the genes within the same cluster are believed to play the same functional role (i.e., a cluster represents the corresponding gens from a set of genomes). In an embodiment, the criteria are as follows:

1) Two genes from the same cluster must be bidirectional best hits of one another (see below for a precise description of the notion “bidirectional best hits”);

2) Each member of the cluster must have fasta similarity scores lower than 1.0 e⁻⁵ with at least two other members of the cluster (implying that each cluster must contain at least three genes, each from distinct genomes); and

3) The regions of similarity between a gene in the cluster and all of the other members of the cluster must overlap.

Clustering analysis requires extensive processor utilization. In an embodiment, comparison analysis based on clustering is pre-computed between the genomes represented in genome information database 105. Thus, gene analysis system 100 only need retrieve the previously determined results in real-time.

Bidirectional best hits 1604 is a second genome comparison routine. Two genes, X from genome G1 and Y from genome G2, are said to be bidirectional best hits if and only if

1) Y is the most similar gene to X in G2, and

2) X is the most similar gen to Y in G1.

Applying this methodology, genome analysis system 100 examines a gene from the template genome and identifies the most similar gene or genes within the comparison genome. For example, given a genome having genes X1, X2, and X3, Gene X1 is compared to a genome having Genes Y1, Y2, and Y3. Suppose, Gene Y3 is identified as being most similar to Gene X1. Gene analysis system 100 then looks in the other direction and compares the characteristics of the gene or genes from the comparison genome to the genes located within the template genome. Continuing with the previous example, Gene Y3 would be compared to Genes X1, X2, and X3. In cases where the characteristics are approximately the same from both perspectives, the gene is saved for display. For example, in the scenario discussed above, if Y3 is identified as being most similar to X1, then there is a bidirectional hit and Y3 would be saved for display. Contrarily, if Y3 is most similar to X3 then there is no bidirectional best hit.

A third genome comparison routine 1606 is based on sequence similarity between the genes located within the template genome and those of the comparison genomes. This routine identifies the gene within the comparison genomes having the closest sequence pattern to the gene from the template and saves it for display.

In order to satisfy the conditions for being “saved for display” (i.e., for similarity) using any of the comparison routines described above, the sequence similarities between the template genes being projected and the genes of the comparison genomes must satisfy a specified similarity threshold. The degree of similarity necessary to satisfy the threshold can be system or user defined. In an embodiment, a fastA cut-off score of at least 1×10⁻⁵ is necessary to satisfy the basic threshold, although the invention is not limited to this.

Genome comparison routines can be combined in any manner to perform step 715. The basic idea is that the ordered use of these comparison routines estimates the gene in the comparison genome that best corresponds to the given gene in the template genome.

In the example embodiment of FIG. 16, clustering analysis 1602 is performed first. If no gene is identified for display (i.e., the template gene does not occur within a cluster containing a gene from the comparison genome) then bidirectional best hits analysis 1604 is performed. If there is still no gene identified for display, then similarity analysis 1606 is performed.

If no gene has been identified for display following the completion of projection routine 715, then no corresponding gene will be displayed within genome comparison screen 400 for the gene being projected.

Upon the completion of step 715, processing continues with step 720. In step 720, any corresponding gene identified for display in step 715 (i.e., those that satisfied the similarity threshold) will be saved. In one embodiment, the corresponding gene is saved temporarily in main memory 206. In other embodiments, the corresponding gene could be saved in secondary memory 208 or removable storage unit 214, for example.

In step 725, genome analysis system 100 determines if additional comparison genomes were identified in step 506. If so, then control returns to step 710.

If there are no additional comparison genomes identified in step 725, then processing continues with step 730.

In step 730, genome analysis system 100 determines if there is another gene in the template genome that has not yet been processed. If so, then control returns to step 705 and the next gene in the template genome is selected for projection.

When all of the genes in the template genome have been projected, then control is passed to step 510 (FIG. 5).

In an embodiment, step 508 is performed for a determined number of genes in the template genome. For example, the user or system could determine that the genes should be analyzed in groups of fifty. Accordingly, step 508 would be performed for the first fifty genes in the template genome. If further comparisons are desired, then the next fifty genes would be selected.

In another embodiment, step 508 is performed for every gene in the template genome.

3.3 Method of Displaying Query Results

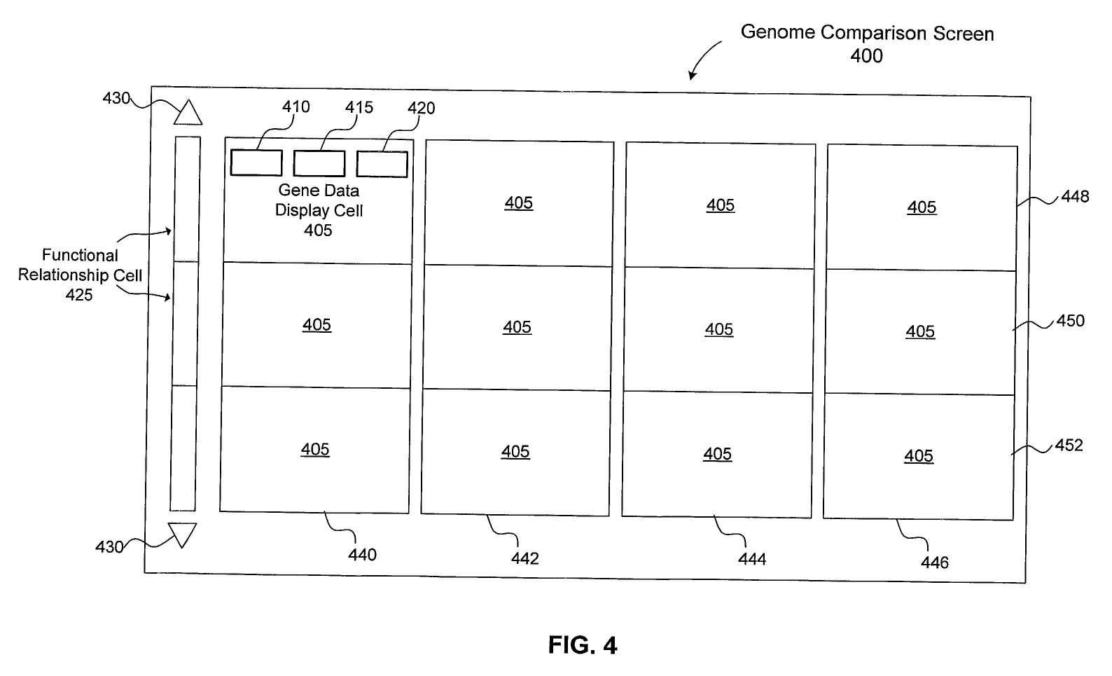

Referring again to FIG. 5, in step 510, genome analysis system 100 generates a genome comparison screen 400 (FIG. 4). In an embodiment, genome comparison screen 400 is displayed in a spreadsheet format. Accordingly, genome comparison screen 400 includes a plurality of gene data display cells 405 arranged in columns and rows.

In an embodiment, each column of gene data display cells 405 represents one genome. Column 440 corresponds to the template genome and contains the genes in the actual chromosomal order in which they appear within the genome. One gene data display cell 405 is provided for each gene of the template genome. Columns 442, 444, and 446 correspond to the comparison genomes.

Each row represents a gene from the template genome and the gene it is projected to in each of the comparison genomes. Consequently, the genes listed in columns 442, 444, and 446 are not necessarily in the chromosomal order in which they appear within their respective comparison genomes. Ordinarily, side by side comparisons of genomes are meaningless unless the genomes align in exact or near exact chromosomal order. However, by displaying the genomes according to the method of the present invention, simultaneous, side by side, comparison of multiple genomes is achieved, irrespective of chromosomal ordering.

In an embodiment, genome analysis system 100 applies highlighting to genome data display cells 405 to identify the strength of the projections. In an embodiment, the strongest correspondence is identified through clustering analysis. Here, the genome data display cell 405 is highlighted in a first color, such as white, for example (other display attributes could alternatively be used). Bidirectional best hits provide the second strongest, i.e., most reliable correspondence and are highlighted in a second color. Projections based on similarity analysis are presented in a third color. By providing highlights to differentiate the strength of the projections, the present invention, provides the user with the ability to quickly identify genes having the strongest correspondence. The user might then decide to begin further detailed analysis with these genes. One skilled in the relevant arts will recognize other ways of emphasizing the comparative results without departing from the scope and spirit of the present invention.

Genome comparison screen 400 further includes navigation icons 430 and functional relationship cells 425. Navigation icons 430 are used to allow a user to navigate forward or backward within genome comparison screen 400.

Functional relationship cells 425 are used to identify the likelihood that a cluster of genes in the template genome are functionally related. This relationship is identified based on the preservation of proximity over substantial phylogenetic distances. Where the examination shows that proximity has been preserved, then evidence of a functional relationship exits.

Gene data display cell 405 also includes gene identifier icon 410, a contiguous region icon 415, and a pathway icon 420. Gene identifier icon 410 allows the user to request a detailed display of data for a specific gene.

Contiguous region icon 415 allows the user to request a display of the portion of the template and comparison genomes where a particular gene is located. The display includes a predetermined number of genes found before and after the particular gene.

Pathway icon 420 allows the user to request a display of the metabolic pathway for a particular gene.

Referring again to FIG. 5, in step 512, the user has the option of performing more detailed analysis by selecting one or more of the icons associated with each gene data display cell 405. In particular, the user can select the following options: (1) obtain detailed gene information; (2) obtain contiguous region detail information; and (3) obtain metabolic pathway information.

In response to the user's selection of genome identifier icon 410, control passes to step 514.

In step 514, genome analysis system 100 retrieves information from genome information database 105 and presents the user with a detailed display of information corresponding to the selected gene. This display conveys to the user information related to the genes aliases, chromosomal address, molecular weight, and function, for example.

In response to the user's selection of contiguous region icon 415, control passes to step 516.

In step 516, genome analysis system 100 retrieves information from genome information database 105 and displays the contiguous region around a specified gene. This display is particularly helpful to the user since the genes from the comparison genomes displayed in genome comparison screen 400 are not necessarily presented in chromosomal order. Here, the user is provided with a display of the selected gene and a number of genes located before and after the selected gene. The number of genes displayed can be user or system defined. From this display, the user is able to view the contiguous region of the gene from the template genome along side the contiguous regions of the corresponding genes from the comparison genomes, each of which is present in their actual chromosomal order.

In response to the user's selection of pathway icon 420, control passes to step 518.

In step 518, genome analysis system 100 retrieves information from genome information database 105 and displays the metabolic pathway corresponding to the specified gene.

In step 520, the user is presented with the option of performing further genome queries. If further queries are desired, control returns to step 506.

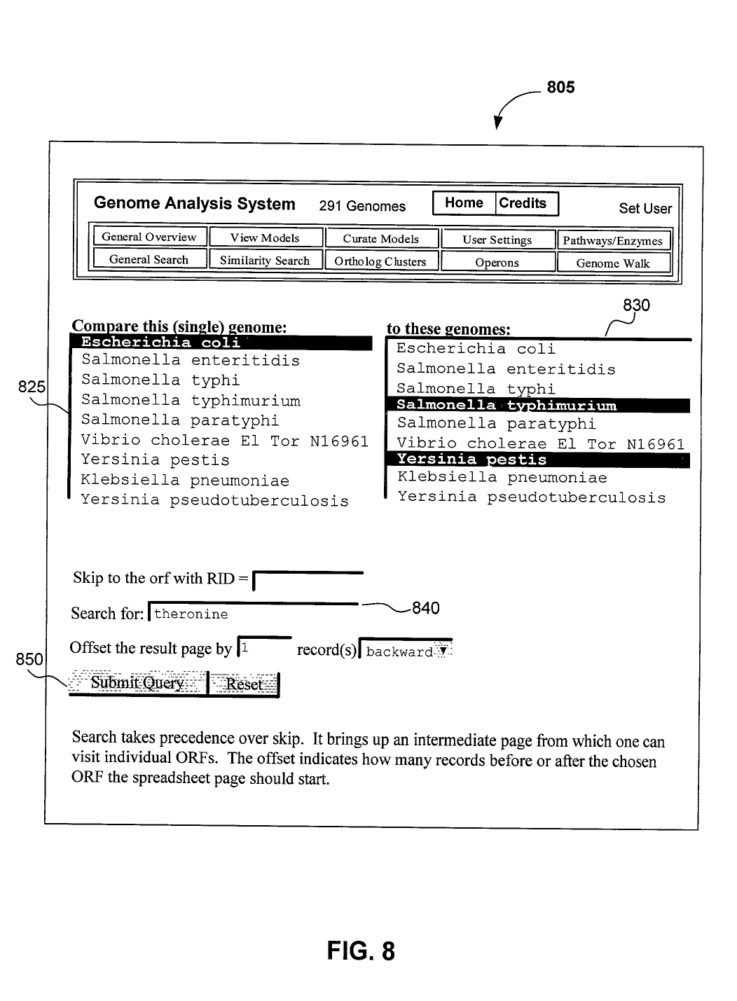

In one embodiment, the user is able to identify additional comparison genomes. In another embodiment, the user is able to identify a new template genome. In this case the new template genome could be another genome selected from genome template selection window 325 or one of the previously identified comparison genomes. If no additional queries are desired, processing ends at step 522. An example implementation of an embodiment of the present invention will now be described with reference to the screen shots shown in FIGS. 8-14.

4. Example Usage of the Invention

4.1 Main Screen Shot

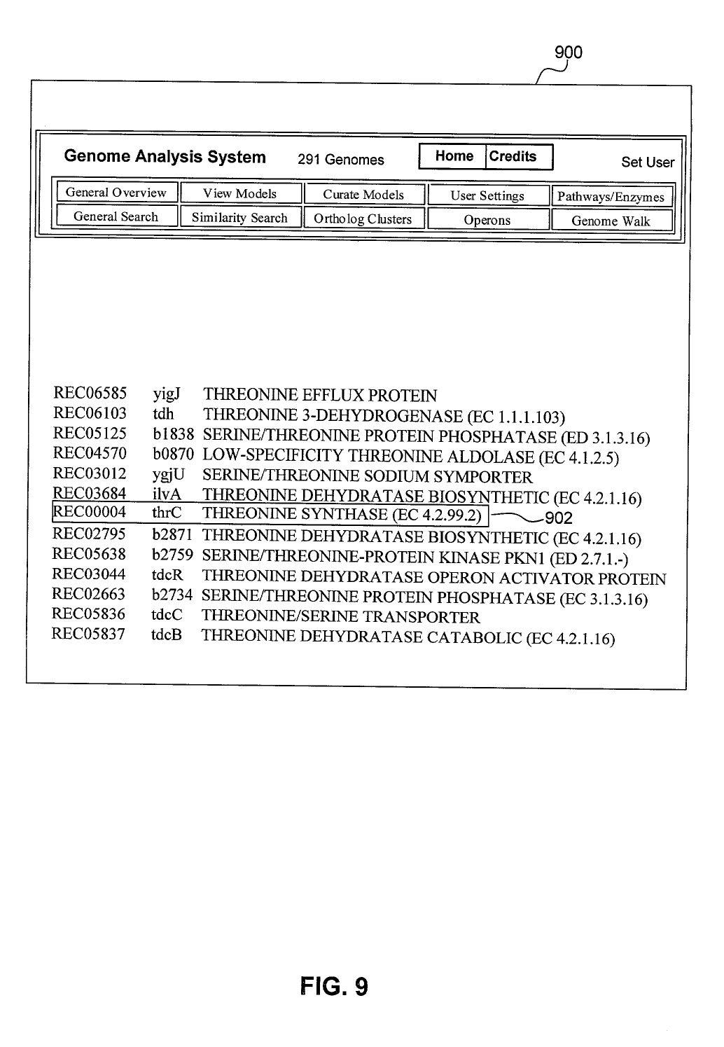

FIG. 8 depicts an example main screen 805 which corresponds to main screen 305 of FIG. 3. Main screen 805 is displayed upon operation of steps 502 and 504. (See FIG. 5) A list of available template and comparison genomes is presented in genome template selection window 825 and comparison genome selection window 830, respectively. In this example, the user has selected Escherichia coli to be the template genome and Salmonella typhimurium and Yersinia pestis to be comparison genomes. The user has further indicated a desire to search for the term “threonine” as indicated in detailed search entry window 840. Upon selecting query execution indicator 850, genome analysis system 100 presents the user with the display 900 (FIG. 9). (See steps 612-618 in FIG. 6)

4.2 Detailed Search Screen Shot

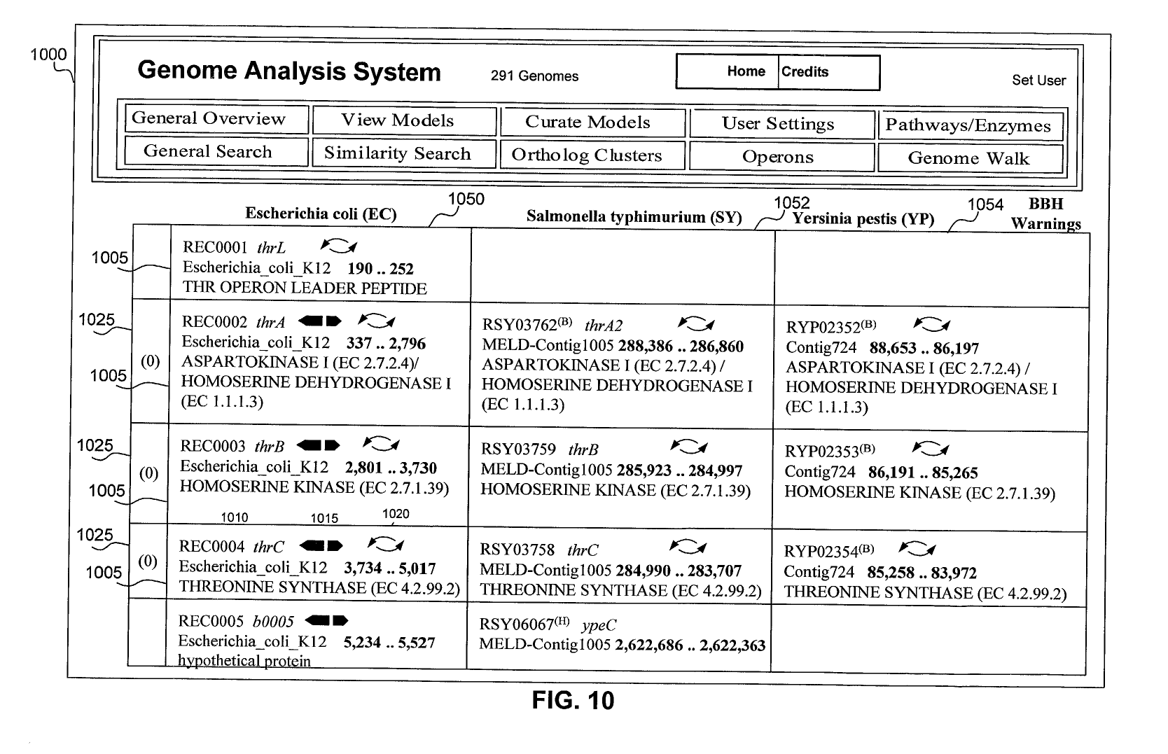

Display 900 lists the genes located within the template genome that contain the search term “Threonine”. As indicated at 902, the user has selected REC0004 as the focal point of the comparison. In response, genome analysis system 100 executes the genome query (step 508) and generates genome comparison screen 1000 (FIG. 10) which corresponds to genome comparison screen 400 in FIG. 4.

4.3 Query Result Display Screen Shot

Genome comparison screen 1000 lists the template genome Escherichia coli in column 1050 and the comparison genomes Salmonella typhimurium and Yersinia pestis in columns 1052 and 1054. Functional Relationship indicator cell 1025 indicates evidence of a functional relationship between genes REC0002, REC0003, and REC0004. Each gene data display cell 1005 in column 1050 contains data corresponding to the genes of the template genome.

From a gene data display cell 1005, the user is able to select gene identifier icon 1010 (corresponding to gene identifier icon 410, FIG. 4), contiguous region icon 1015 (corresponding to contiguous region icon 415), or pathway icon 1020 (corresponding to pathway icon 420).

4.4 Gene Detailed Description Screen Shot

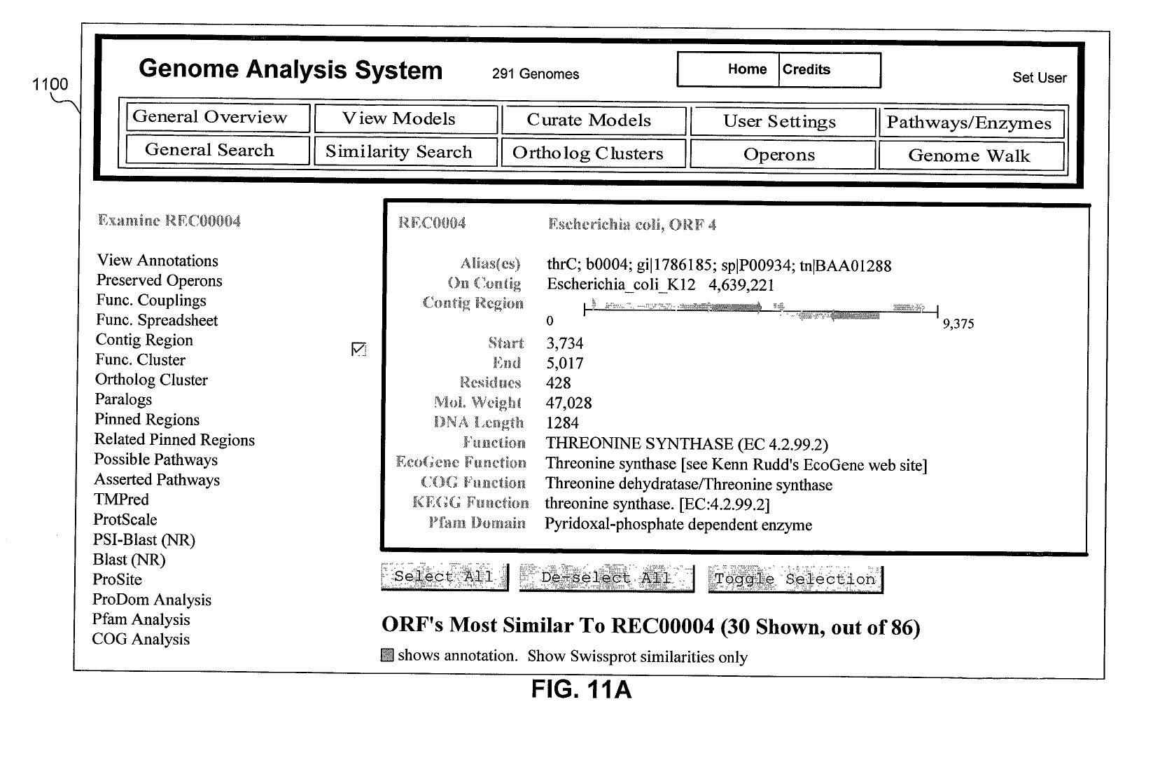

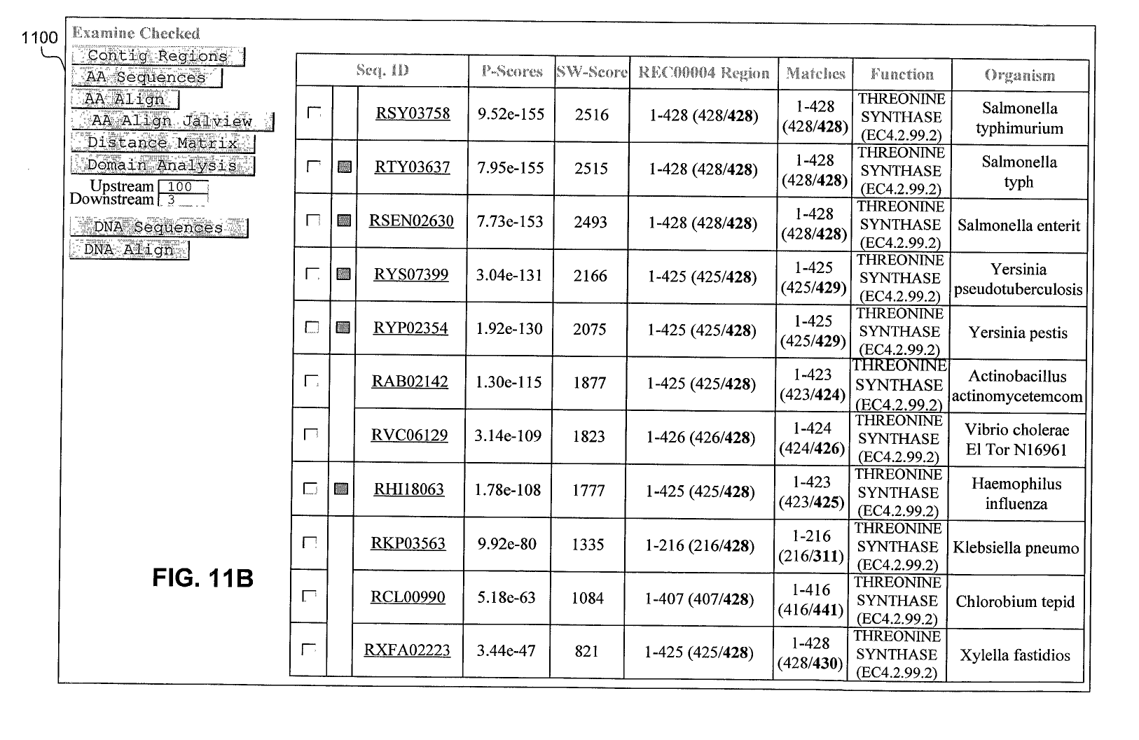

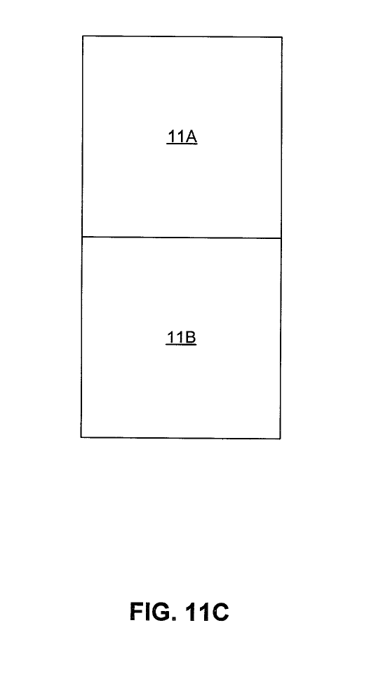

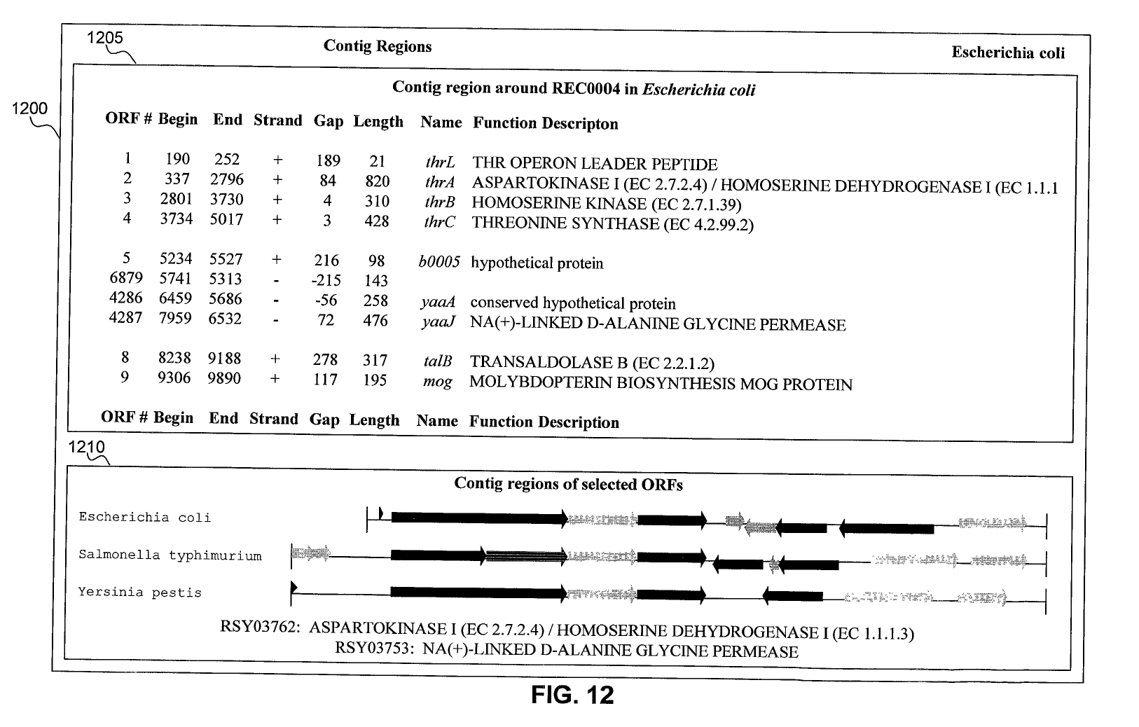

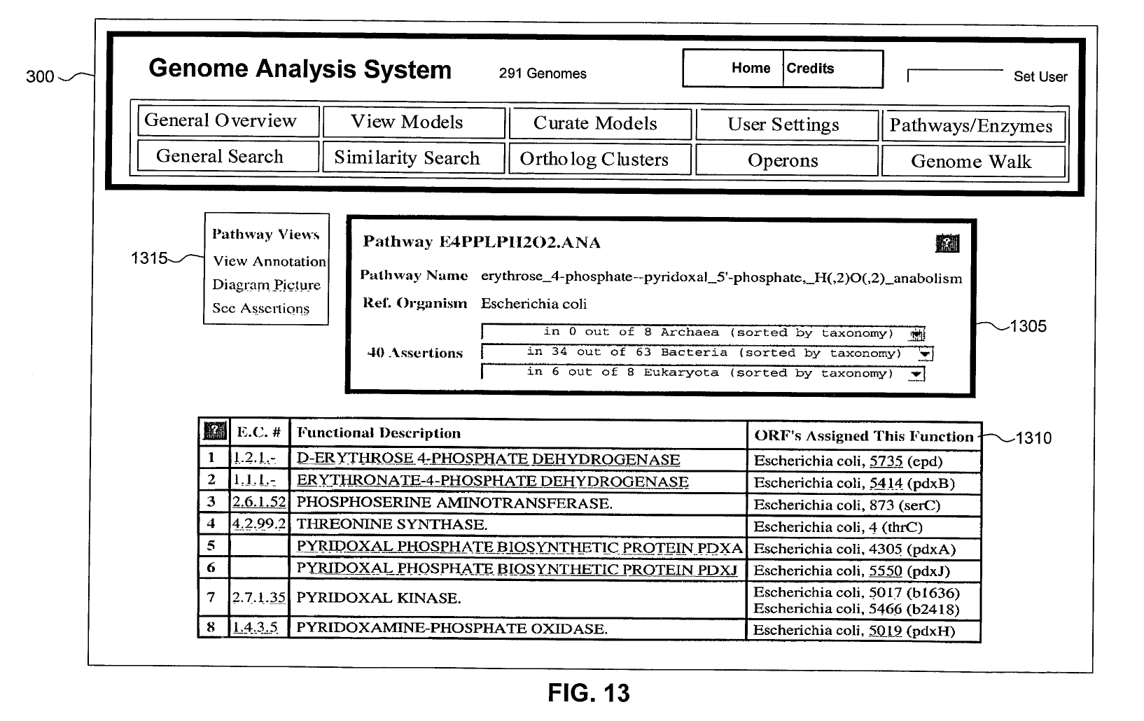

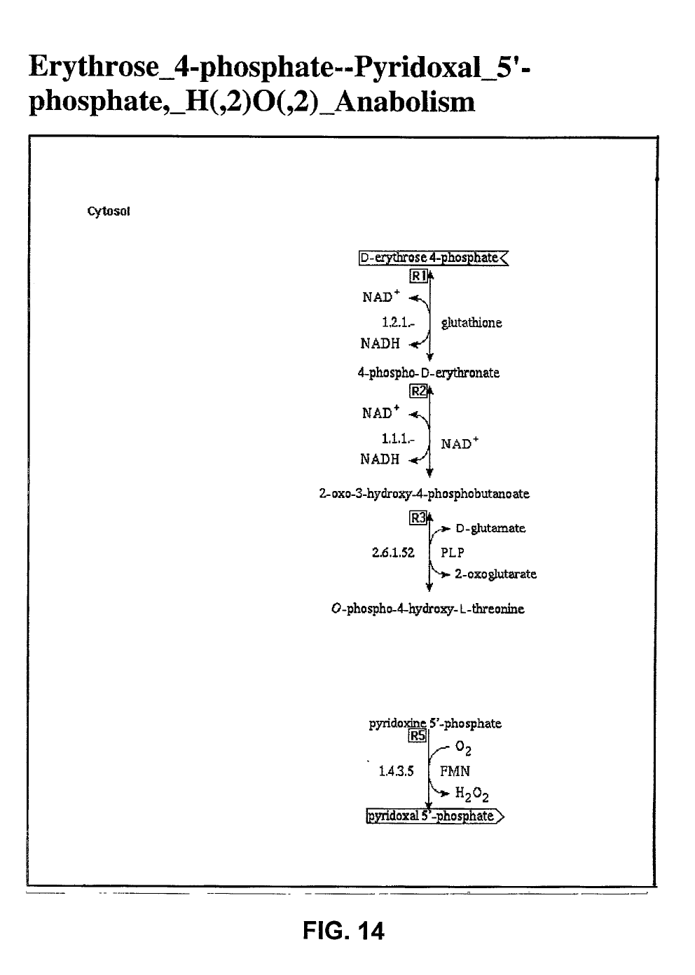

The selection of gene identifier icon 1010 (step 514) causes genome analysis system 100 to present gene detailed display window 1100 (FIGS. 11A-B). FIG. 11C demonstrates one possible way of orienting gene detailed display window 1100. Accordingly, the user can navigate forwards and backwards as necessary.

4.5 Contiguous Region Screen Shot

The selection of contiguous region icon 1015 (step 516) causes genome analysis system 100 to present contiguous region display screen 1200 (FIG. 12). Contiguous region display screen 1200 includes window 1205 displaying the contiguous regions associated with the specified gene REC0004. Window 1210 provides a pictorial display of the contiguous regions of the specified gene and the corresponding genes of the comparison genomes in their actual chromosomal orders.

This display is particularly helpful to the user since the genes from the comparison genomes displayed in genome comparison screen 400 are not necessarily presented in chromosomal order (instead, each row displayed in the genome comparison screen 400 depicts genes that are functionally similar, irrespective of the chromosomal ordering of the genes in the comparison genomes). Here in FIG. 12, the user is provided with a display of the selected gene and a number of genes located before and after the selected gene. From this display, the user is able to view the contiguous region of the gene from the template genome along side the contiguous regions of the corresponding genes from the comparison genomes in their actual chromosomal order.

4.6 Metabolic Pathway Description Screen Shot

The selection of pathway icon 1020 (step 518) causes gene analysis system 100 to display pathway screen 1300 (FIG. 13). Pathway screen 1300 includes a pathway description window 1305. Pathway description window 1305 provides information related to the pathway name, reference organism, and assertions.

Pathway screen 1300 further includes pathway function display window 1310. Pathway function display window 1310 isolates each portion of the pathway and its particular function.

4.7 Metabolic Pathway View Screen Shot

Pathway screen 1300 also includes a pathway view menu 1315. From the pathway view menu 1315, the user is able to select options leading to more detailed information about the metabolic pathway. For example, selecting “Diagram Picture” would result in the display of pathway flowchart 1400 (FIG. 14). Pathway flowchart 1400 provides a flow diagram of the functional pathway for the specified gene REC0004.

5. Conclusion

While various embodiments of the present invention have been described above, it should be understood that they have been presented by way of example only and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A system for analyzing multiple genomes simultaneously, comprising:
a genome information database for storing genome information; and
a genome analysis module in communications with said genome information database, wherein said genome analysis module uses said stored genome information to project a template genome over at least one comparison genome irrespective of chromosomal ordering of said at least one comparison genome.

2. The system of claim 1, further comprising a graphical user interface for aligning in a display, genes of said template genome proximate to genes of said at least one comparison genome based on functional similarity.

3. The system of claim 1, wherein said genome analysis module provides a genome comparison screen comprising a plurality of gene data cells arranged in columns and rows, wherein each column corresponds to a genome and each row contains genes of said template genome and said at least one comparison genome that are functionally similar.

4. A method of analyzing multiple genomes simultaneously, comprising the steps of:
(1) enabling selection of a first genome;
(2) enabling selection of a second genome;
(3) projecting said first genome over said second genome to identify genes of said first and second genomes that are functionally similar;
(4) generating a display wherein genes of said first and second genomes that are functionally similar are positioned next to each other; and
(5) enabling display of said display;
wherein step (4) comprises the steps of:
(i) ensuring that chromosomal ordering of genes of said first genome is maintained when generating said display; and
(ii) ensuring that genes of said second genome are positioned next to functionally similar genes of said first genome, irrespective of chromosomal ordering of genes of said second genome.

5. A computer program product comprising a computer useable medium and control logic stored herein, said control logic enabling a computer to assist in simultaneously analyzing multiple genomes, said control logic comprising:
means for enabling the computer to project a first genome over a second genome to identify genes of said first and second genomes that are functionally similar;
display generating means for enabling the computer to generate a display wherein genes of said first and second genomes that are functionally similar are positioned next to each other;
wherein said display generating means comprises:
means for enabling the computer to ensure that chromosomal ordering of genes of said first genome is maintained when generating said display; and
means for enabling the computer to ensure that genes of said second genome are positioned next to functionally similar genes of said first genome, irrespective of chromosomal ordering of genes of said second genome.
